(19) United States
(12) Patent Application Publication
(10) Pub. No.: US 2020/0131960 A1
(43) Pub. Date: Apr. 30, 2020

(54) CATALYTIC DEVICE AND EXHAUST GAS PURIFICATION SYSTEM

(71) Applicant: TOYOTA JIDOSHA KABUSHIKI KAISHA, Toyota-shi (JP)

(72) Inventor: Tetsuya SAKUMA, Gotemba-shi (JP)

(73) Assignee: TOYOTA JIDOSHA KABUSHIKI KAISHA, Toyota-shi (JP)

(21) Appl. No.: 16/595,349

(22) Filed: Oct. 7, 2019

(30) Foreign Application Priority Data
Oct. 26, 2018 (JP) 2018-201927

(51) Int. Cl. F01N 3/20; F01N 3/28; F01N 3/10; B01D 53/94; H05B 6/70; B01J 23/44; B01J 23/46; B01J 35/00; B01J 35/04

(52) U.S. Cl. CPC F01N 3/202; B01D 2255/904; F01N 3/101; B01D 53/945; H05B 6/701; B01J 23/44; B01J 23/464; B01J 35/0006; B01J 35/04; F01N 2330/34; F01N 2370/02; F01N 2510/0682; F01N 2510/0684; B01D 2255/9022; B01D 2255/1023; B01D 2255/1025; F01N 3/2803

(57) ABSTRACT

The present disclosure is intended to improve HC purification performance of a catalytic device arranged in an exhaust passage of an internal combustion engine in a more suitable manner. A microwave absorber is distributed over a predetermined part in a catalytic layer of the catalytic device which is irradiated with a microwave in the exhaust passage of the internal combustion engine. Then, in the predetermined part in the catalytic layer, a content ratio of a first catalytic material, which is one of two kinds of catalytic materials of which HC purification performance is higher than that of the other, is higher than a content ratio of the first catalytic material in the other portion than the predetermined part in the catalytic layer.

### CROSS REFERENCE TO THE RELATED APPLICATION

This application claims the benefit of Japanese Patent Application No. 2018-201927, filed on Oct. 26, 2018, which is hereby incorporated by reference herein in its entirety.

### BACKGROUND

### Technical Field

The present disclosure relates to a catalytic device arranged in an exhaust passage of an internal combustion engine, and to an exhaust gas purification system for an internal combustion engine.

### Description of the Related Art

In patent document 1, there is disclosed a technique for a catalytic converter having a catalyst of a small capacity and another catalyst of a large capacity arranged at the downstream side of the small capacity catalyst. With the technique described in this patent document 1, the small capacity catalyst is formed by coating a catalytic coating material containing a catalytic material made of noble metal and a microwave absorber on a substrate made of ceramics. Then, a microwave is irradiated to the small capacity catalyst by means of a microwave oscillator arranged in a catalytic converter.

### CITATION LIST

### Patent Document

First Patent document: Japanese patent application laid-open publication No. H05-222924

### SUMMARY

As mentioned above, there is known a catalytic device which is configured to include a microwave absorber in addition to a catalytic material. When a microwave is irradiated to the catalytic device configured to include the microwave absorber, the microwave absorber absorbs the microwave thereby to generate heat. With this, the temperature rise of the catalytic device is promoted, thus making it possible to attain early activation of the catalytic material included in the catalytic device. Then, in an internal combustion engine, exhaust emission can be improved by activating the catalytic material in the catalytic device arranged in the exhaust passage at an early stage. However, further improvement is required in HC (hydrocarbon) purification (oxidation) performance of the catalytic device.

The present disclosure has been made in view of the above-mentioned circumstances, and has for its object to improve the HC purification (oxidation) performance of a catalytic device arranged in an exhaust passage of an internal combustion engine in a more suitable manner.

A catalytic device according to a first aspect of the present disclosure may be arranged in an exhaust passage of an internal combustion engine, and may be irradiated with a microwave in the exhaust passage, the catalytic device having a catalytic layer configured to include at least two kinds of catalytic materials that are different from each other in HC purification performance, and a microwave absorber to generate heat by absorbing the microwave, wherein the microwave absorber is distributed over a predetermined part in the catalytic layer, and in the predetermined part in the catalytic layer, a content ratio of a first catalytic material, which is one of the two kinds of catalytic materials which is higher in the HC purification performance than the other, is higher than a content ratio of the first catalytic material in the other part than the predetermined part in the catalytic layer.

The catalytic device according to the present disclosure may be arranged in the exhaust passage of the internal combustion engine as an exhaust gas purification apparatus. The catalytic device may have the catalytic layer. The catalytic layer may be configured to include the at least two kinds of catalytic materials that are different from each other in the HC purification performance. Each of the catalytic materials is a noble metal. In the catalytic device arranged in the exhaust passage of the internal combustion engine, when the catalytic materials included in the catalytic layer are activated, an exhaust gas is purified by the catalytic materials. Here, one of the two kinds of catalytic materials may be higher in the HC purification performance than the other, and the other may be higher in NOx purification (reduction) performance than the one.

In addition, the catalytic layer may be configured to include the microwave absorber in addition to the catalytic materials. The microwave absorber may be a substance that has a microwave absorption performance higher than those of the catalytic materials included in the catalytic layer. The microwave is irradiated to the catalytic device arranged in the exhaust passage of the internal combustion engine. The microwave absorber has a property of generating heat by absorbing the microwave irradiated to the catalytic device. Then, in the present disclosure, the microwave absorber may be distributed over the predetermined part in the catalytic layer of the catalytic device. In other words, the microwave absorber may be distributed not uniformly but partially in the catalytic layer of the catalytic device.

Moreover, in the catalytic layer of the catalytic device, the at least two kinds of the catalytic materials with their HC purification performances different from each other may be not distributed uniformly, either. Here, one of the two kinds of catalytic materials with its HC purification performance higher than that of the other is referred to as the first catalytic material. Then, in the catalytic layer, the content ratio of the first catalytic material in the predetermined part over which the microwave absorber is distributed is higher than the content ratio of the first catalytic material in the other part than the predetermined part (i.e., that part over which the microwave absorber is not distributed). Here, the content ratio of the first catalytic material is a ratio of an amount of the first catalytic material with respect to an amount of all the catalytic materials in a certain portion of the catalytic layer.

In cases where the catalytic device as mentioned above is arranged in the exhaust passage, when the microwave is irradiated to the catalytic device, the temperature rise of the predetermined part over which the microwave absorber is distributed in the catalytic layer will be promoted more than in the other part than the predetermined part. For that reason, in the catalytic layer, the first catalytic material distributed over the predetermined part at a ratio higher than that in the other part than the predetermined part can be activated at an earlier stage. In other words, according to the present disclosure, the activation of the first catalytic material can be promoted more when the microwave is irradiated, in comparison with the case where the same amount of the first catalytic material is uniformly distributed in the catalytic layer of the catalytic device. As a result, the HC purification performance of the catalytic device can be improved.

Further, in the catalytic layer, by distributing the microwave absorber over the predetermined part alone, it becomes possible to reduce an irradiation amount of microwave required for activating the first catalytic material at an early stage, in comparison with the case where a larger amount of the microwave absorber is uniformly distributed in the catalytic layer. Accordingly, an amount of electric power required for the irradiation of microwave to the catalytic device can be reduced.

In addition, in the present disclosure, the predetermined part in the catalytic layer may be a portion thereof located at an upstream side along the flow of the exhaust gas (hereinafter, sometimes also referred to as an “upstream portion”) in the case where the catalytic device is arranged in the exhaust passage. In the case where the catalytic device is arranged in the exhaust passage, the upstream portion of the catalytic layer is easily heated by the exhaust gas, in comparison with a portion thereof located at a downstream side along the flow of the exhaust gas (hereinafter, sometimes also referred to as a “downstream portion”). Accordingly, by forming the predetermined part of the catalytic layer having a relatively high content ratio of the first catalytic material in the upstream portion thereof, it is possible to promote the temperature rise of the first catalytic material included in the predetermined part. For that reason, further early activation of the first catalytic material can be attained.

Moreover, when the temperature of the upstream portion of the catalytic layer rises, the heat generated in the upstream portion will easily conduct to the downstream portion thereof by the flow of the exhaust gas. For that reason, by promoting the temperature rise of the upstream portion of the catalytic layer, the temperature rise of the catalytic layer as a whole can also be promoted. Accordingly, by forming the predetermined part including the microwave absorber in the upstream portion, it is possible to attain early activation of not only the first catalytic material distributed over the upstream portion (the predetermined part) of the catalytic layer but also the first catalytic material distributed over the downstream portion of the catalytic layer.

Further, in the present disclosure, the catalytic device may have a plurality of cells divided by a partition wall. In this case, the plurality of cells are formed so as to extend from the upstream side to the downstream side along the flow of the exhaust gas in the catalytic device. Then, the catalytic layer may be formed on the partition wall which defines the plurality of cells. With such a structure, when the catalytic device is arranged in the exhaust passage, the exhaust gas will flow through the interiors of the plurality of cells. At this time, the predetermined part in the catalytic layer may be a portion thereof (hereinafter, sometimes also referred to as “an exhaust gas contacting portion”) that is located in a place directly exposed to the exhaust gas flowing through the interiors of the cells. Here, in cases where the temperature of the exhaust gas is higher than the temperature of the catalytic layer, the exhaust gas contacting portion in the catalytic layer is easily heated with the heat of the exhaust gas in comparison with a portion thereof (hereinafter, sometimes also referred to as “an exhaust gas non-contacting portion”) that is located in a place not directly exposed to the exhaust gas. Accordingly, by forming the predetermined part in the exhaust gas contacting portion in the catalytic layer, too, it is possible to promote the temperature rise of the first catalytic material included in the predetermined part. For that reason, further early activation of the first catalytic material can be attained.

On the other hand, the predetermined part in the catalytic layer may be the exhaust gas non-contacting portion. Here, in cases where the temperature of the exhaust gas is lower than the temperature of the catalytic layer, heat is carried away from the catalytic layer by the exhaust gas. However, even in such a time, in the catalytic layer, heat can not be easily carried away from the exhaust gas non-contacting portion by the exhaust gas in comparison with the exhaust gas contacting portion. Accordingly, by forming the predetermined part in the exhaust gas non-contacting portion in the catalytic layer, it is possible to suppress the temperature of the first catalytic material once activated in the predetermined part from becoming low due to carrying away of heat by the exhaust gas.

An exhaust gas purification system for an internal combustion engine according to a second aspect of the present disclosure may comprise: a catalytic device arranged in an exhaust passage of the internal combustion engine, according to the first aspect of the present disclosure; and an irradiation device configured to irradiate a microwave to the catalytic device in the exhaust passage.

According to such an exhaust gas purification system, the HC purification performance of the catalytic device can be improved, and at the same time, the amount of electric power required for irradiating the microwave from the irradiation device to the catalytic device can be reduced.

According to the present disclosure, it is possible to improve the HC purification performance of a catalytic device arranged in an exhaust passage of an internal combustion engine in a more suitable manner.

### BRIEF DESCRIPTION OF THE DRAWINGS

FIG. 1 is a view illustrating the schematic construction of an exhaust system of an internal combustion engine according to an embodiment.

FIG. 2 is a view enlarging a part of a cross section of a catalytic device in a direction perpendicular to the direction of flow of exhaust gas.

FIG. 3 is a view enlarging a part of a cross section of the catalytic device in a direction along the direction of flow of exhaust gas.

FIG. 4 is time chart respectively illustrating changes over time of an HC purification (oxidation) ratio and an NOx purification (reduction) ratio in the catalytic device at the time when a microwave is irradiated to the catalytic device at cold start of the internal combustion engine.

FIG. 5 is a view illustrating a first modification of the distribution of a first catalytic layer and a second catalytic layer in a catalytic layer of the catalytic device.

FIG. 6 is a view illustrating a second modification of the distribution of the first catalytic layer and the second catalytic layer in the catalytic layer of the catalytic device.

FIG. 7 is a view illustrating a third modification of the distribution of the first catalytic layer and the second catalytic layer in the catalytic layer of the catalytic device.

### DESCRIPTION OF THE EMBODIMENTS

Hereinafter, specific embodiments of the present disclosure will be described based on the attached drawings. However, the dimensions, materials, shapes, relative arrangements and so on of component parts described in the embodiments are not intended to limit the technical scope of the present disclosure to these alone in particular as long as there are no specific statements.

### (Schematic Construction of Exhaust System)

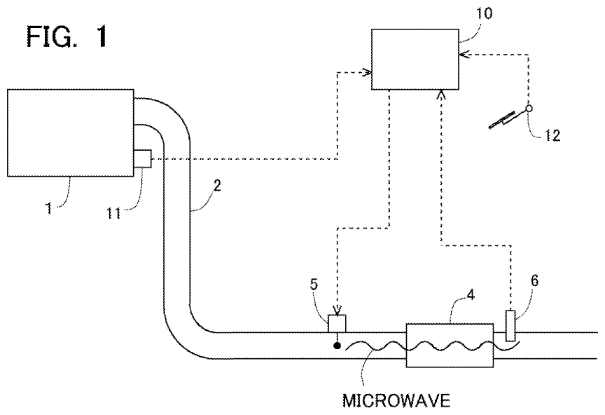

FIG. 1 is a view illustrating the schematic construction of an exhaust system of an internal combustion engine according to an embodiment. The internal combustion engine denoted by 1 is a gasoline engine for driving a vehicle. An exhaust passage 2 is connected to the internal combustion engine 1. A catalytic device 4 is arranged in the exhaust passage 2. This catalytic device 4 is a three-way catalyst for purifying or removing HC (hydrocarbon), CO (carbon monoxide), and NOx (nitrogen oxides) in the exhaust gas. Here, note that the configuration of the catalytic device 4 will be described later. In addition, a temperature sensor 6 is arranged in the exhaust passage 2 at the downstream side of the catalytic device 4. The temperature sensor 6 is to detect the temperature of exhaust gas flowing out of the catalytic device 4.

In addition, an irradiation device 5 is arranged in the exhaust passage 2 at the upstream side of the catalytic device 4. The irradiation device 5 is to irradiate a microwave to the catalytic device 4. The irradiation device 5 is provided with a microwave oscillator and a microwave radiator. As the microwave oscillator, there can be used a semiconductor oscillator, for example. Then, the irradiation device 5 irradiates the microwave generated by the microwave oscillator to the catalytic device 4 from the microwave radiator. Here, note that, in this embodiment, the catalytic device 4 corresponds to a “catalytic device” according to the present disclosure, and the irradiation device 5 corresponds to an “irradiation device” according to the present disclosure.

Moreover, an electronic control unit (ECU) 10 is provided in combination with the internal combustion engine 1. Various devices such as a throttle valve arranged in an intake passage of the internal combustion engine 1, fuel injection valves of the internal combustion engine 1, etc., are electrically connected to the ECU 10. Thus, these devices are controlled by the ECU 10.

Also, the temperature sensor 6 is electrically connected to the ECU 10. Further, a crank position sensor 11 and an accelerator opening sensor 12 are electrically connected to the ECU 10. Then, detected values of the individual sensors are inputted to the ECU 10. The ECU 10 estimates the temperature of the catalytic device 4 based on the detected value of the temperature sensor 6. In addition, the ECU 10 derives an engine rotational speed of the internal combustion engine 1 based on the detected value of the crank position sensor 11. Also, the ECU 10 derives an engine load of the internal combustion engine 1 based on the detected value of the accelerator opening sensor 12.

Moreover, the irradiation device 5 is electrically connected to the ECU 10. The ECU 10 carries out microwave irradiation processing by controlling the irradiation device 5. The microwave irradiation processing is to irradiate a microwave of a predetermined frequency to the catalytic device 4. The microwave irradiation processing is carried out in cases where there is a request for raising the temperature of the catalytic device 4, for example, such as when the internal combustion engine 1 is cold started. In this case, the predetermined frequency in the microwave irradiation processing is decided based on experiments, etc., as a frequency suitable for raising the temperature of the catalytic device 4.

### (Catalytic Device)

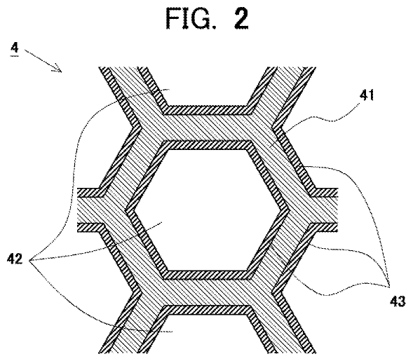

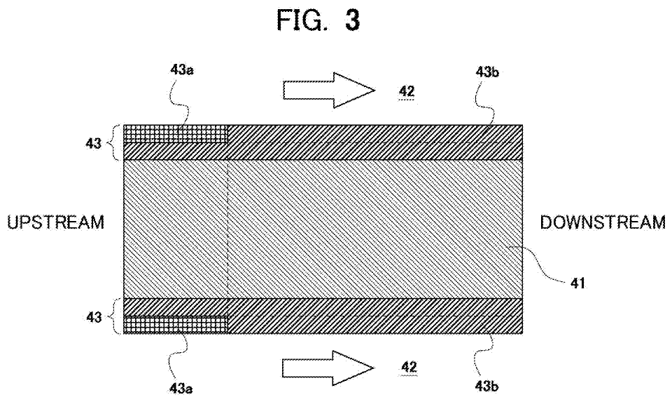

Here, the schematic configuration of the catalytic device 4 according to this embodiment will be explained based on FIG. 2 and FIG. 3. FIG. 2 is a view enlarging a part of a cross section of the catalytic device 4 in a direction perpendicular to the direction of flow of exhaust gas. FIG. 3 is a view enlarging a part of a cross section of the catalytic device 4 in a direction along the direction of flow of exhaust gas.

The catalytic device 4 is a three-way catalyst of wall-flow type having a plurality of cells 42 extending in the direction of flow of exhaust gas. In the catalytic device 4, each cell 42 is divided by a partition wall 41. As illustrated in FIG. 2, in the catalytic device 4, a catalytic layer 43 is formed by a coating material containing catalytic materials composed of noble metals on the partition wall 41 in a substrate (i.e., on the wall surface of each cell 42). This catalytic layer 43 is configured to include at least two kinds of catalytic materials, i.e., a first catalytic material and a second catalytic material. Here, the first catalytic material is a substance which is higher in HC purification (oxidation) performance and CO purification (oxidation) performance than the second catalytic material. In addition, the second catalytic material is a substance which is higher in NOx purification (reduction) performance than the first catalytic material. Note that Pd (palladium) can be exemplified as the first catalytic material, and Rh (rhodium) can be exemplified as the second catalytic material. Then, in the catalytic device 4, HC, CO and NOx in the exhaust gas are removed (oxidized or reduced) by the individual catalytic materials included in the catalytic layer 43.

Further, a microwave absorber in addition to the catalytic materials is included in the catalytic layer 43. The microwave absorber is a substance that is higher in microwave absorption performance than each of the catalytic materials included in the catalytic layer 43. In addition, the microwave absorber has a property of generating heat by absorbing the microwave of the predetermined frequency irradiated from the irradiation device 5 to the catalytic device 4. Here, note that SiC (silicon carbide) can be exemplified as the microwave absorber.

However, in the catalytic layer 43 of the catalytic device 4, the above-mentioned two kinds of catalytic materials and the microwave absorber are not necessarily distributed uniformly. Specifically, the catalytic layer 43 of the catalytic device 4 has a first catalytic layer 43a and a second catalytic layer 43b which are mutually different from each other in the ratio of the substances included therein, as illustrated in FIG. 3. FIG. 3 illustrates the distribution of the first catalytic layer 43a and the second catalytic layer 43b in the catalytic layer 43 formed on the partition wall 41 of the catalytic device 4. Here, note that in FIG. 3, white arrows (defined by outlines) indicate the direction of flow of exhaust gas flowing in cells 42.

As mentioned above, in the catalytic device 4, the catalytic layer 43 is formed on the partition wall 41 which divides the cells 42 extending along the flow of the exhaust gas. Then, the first catalytic layer 43a is distributed over a predetermined part in this catalytic layer 43. Specifically, as illustrated in FIG. 3, in the catalytic layer 43, the first catalytic layer 43a is formed in an upstream portion thereof which is located at the upstream side along the f low of the exhaust gas, and in an exhaust gas contacting portion which is located in a place directly exposed to the exhaust gas flowing in the cells 42 (i.e., a portion of the catalytic layer 43 which is in non-contact with the partition wall 41 in cases where the catalytic layer 43 is divided into two in a direction perpendicular to the partition wall 41). In addition, the second catalytic layer 43b is formed in the other portion than the predetermined part in the catalytic layer 43 (i.e., that portion of the catalytic layer 43 which is other than the portion in which the first catalytic layer 43a is formed). In other words, in the catalytic layer 43, the second catalytic layer 43b is formed in an exhaust gas non-contacting portion which is located in a place not directly exposed to the exhaust gas flowing in the cells 42 in the upstream side portion in which the first catalytic layer 43a is formed (i.e., that portion of the catalytic layer 43 which is in contact with the partition wall 41 in cases where the catalytic layer 43 is divided into two in the direction perpendicular to the partition wall 41), and in a downstream side portion located at the downstream side of that portion in which the first catalytic layer 43a is formed, along the flow of the exhaust gas.

Then, in the catalytic layer 43, a content ratio of the first catalytic material in the first catalytic layer 43a is higher than a content ratio of the first catalytic material in the second catalytic layer 43b. In addition, in the catalytic layer 43, a content ratio of the second catalytic material in the second catalytic layer 43b is higher than a content ratio of the second catalytic material in the first catalytic layer 43a. Here, note that there can also be adopted a configuration in which only the first catalytic material among the first and second catalytic materials is included in the first catalytic layer 43a, and only the second catalytic material among the first and second catalytic materials is included in the second catalytic layer 43b. Further, in the catalytic layer 43, the microwave absorber is included only in the first catalytic layer 43a. That is, the microwave absorber is not included in the second catalytic layer 43b.

### Advantageous Effects of the Configuration of this Embodiment

As described above, in this embodiment, in the catalytic layer 43, the microwave absorber is included only in the first catalytic layer 43a. Accordingly, when a microwave is irradiated to the catalytic device 4 by means of the irradiation device 5, the temperature rise of the first catalytic layer 43a will be more promoted than the temperature rise of the second catalytic layer 43b resulting from heat generation of the microwave absorber included in the first catalytic layer 43a. Then, as mentioned above, in the catalytic layer 43, the content ratio of the first catalytic material in the first catalytic layer 43a is higher than the content ratio of the first catalytic material in the second catalytic layer 43b. For that reason, when the temperature rise of the first catalytic layer 43a is promoted, the first catalytic material distributed in the first catalytic layer 43a at a ratio higher than the second catalytic layer 43b will be activated at an earlier stage. In other words, according to the configuration of the catalytic device 4 according to this embodiment, when the microwave is irradiated, it becomes possible to more promote the activation of the first catalytic material, in comparison with the case where the same amount of the first catalytic material is uniformly distributed in the catalytic layer 43 of the catalytic device 4 (i.e., in cases where the first catalytic material is distributed over the catalytic layer 43 in such a manner that the content ratio of the first catalytic material in the first catalytic layer 43a in which the microwave absorber is included, and the content ratio of the first catalytic material in the second catalytic layer 43b in which the microwave absorber is not included become uniform or the same).

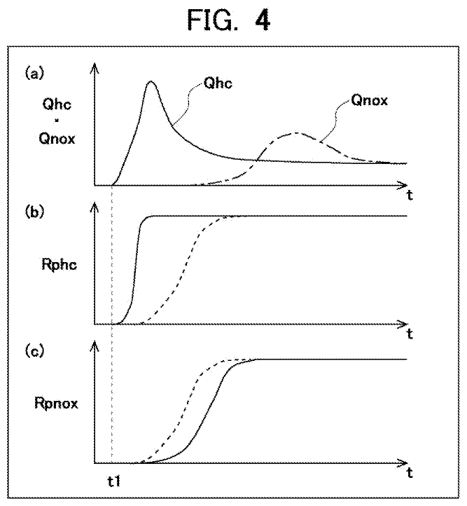

Here, changes over time of an HC purification (oxidation) ratio and an NOx purification (reduction) ratio in the catalytic device 4 at the time when the microwave is irradiated from the irradiation device 5 to the catalytic device 4 at cold start of the internal combustion engine 1 will be explained based on FIG. 4. In (a) of FIG. 4, a solid line represents the change over time of an amount of HC Qhc discharged from the internal combustion engine 1 (i.e., an amount of HC flowing into the catalytic device 4), and an alternate long and short dash line represents the change over time of an amount of NOx Qnox discharged from the internal combustion engine 1 (i.e., an amount of NOx flowing into the catalytic device 4). In addition, in (b) of FIG. 4, a solid line represents an HC purification (oxidation) ratio Rphc in the catalytic device 4. Here, note that in (b) of FIG. 4, a broken line represents the change over time of the HC oxidation ratio Rphc in the catalytic device 4 in the case of adopting the configuration in which the same amount of the first catalytic material is uniformly distributed in the catalytic layer 43 of the catalytic device 4. Moreover, in (c) of FIG. 4, a solid line represents the change over time of an NOx purification (reduction) ratio Rpnox in the catalytic device 4. Here, note that in (c) of FIG. 4, a broken line represents the change over time of the NOx reduction ratio Rpnox in the catalytic device 4 in the case of adopting the configuration in which the same amount of the first catalytic material is uniformly distributed in the catalytic layer 43 of the catalytic device 4. In each of (a), (b), and (c) of FIG. 4, an axis of abscissa represents time t.

In (a), (b), and (c) of FIG. 4, at time t1, the internal combustion engine 1 is started, and the irradiation of a microwave from the irradiation device 5 to the catalytic device 4 is also started. Here, at the time of the cold start of the internal combustion engine 1, the amount of HC emission from the internal combustion engine 1 rapidly increases immediately after the engine starting, as illustrated in (a) of FIG. 4. This is because the temperature of combustion in the internal combustion engine 1 immediately after the starting thereof is low. At this time, in this embodiment, by the irradiation of the microwave from the irradiation device 5 to the catalytic device 4, the first catalytic material is rapidly activated in the first catalytic layer 43a of the catalytic device 4. As a result, as illustrated in (b) of FIG. 4, immediately after the starting of the internal combustion engine 1 in which the amount of HC emission from the internal combustion engine 1 rapidly increases, the HC oxidation ratio in the catalytic device 4 can be made to increase rapidly. In other words, the HC oxidation ratio in the catalytic device 4 can be raised earlier and more quickly, in comparison with the case where the same amount of the first catalytic material is uniformly distributed in the catalytic layer 43 of the catalytic device 4. In this manner, according to the configuration of this embodiment, the HC oxidation performance of the catalytic device 4 can be improved.

In addition, in the catalytic layer 43, by distributing the microwave absorber over the first catalytic layer 43a alone, it becomes possible to reduce an irradiation amount of microwave required for activating the first catalytic material included in the first catalytic layer 43a at an early stage, in comparison with the case where a larger amount of the microwave absorber is uniformly distributed in the catalytic layer 43. Accordingly, an amount of electric power required for the irradiation of the microwave to the catalytic device 4 by the irradiation device 5 can be reduced.

Here, note that, with the configuration according to this embodiment, the amount of the second catalytic material included in the first catalytic layer 43a becomes smaller, and the amount of the second catalytic material included in the second catalytic layer 43b becomes larger, in comparison with the case where the same amount of the first catalytic material is uniformly distributed in the catalytic layer 43 of the catalytic device 4. For that reason, even if the microwave absorber included in the first catalytic layer 43a generates heat by the irradiation of the microwave by means of the irradiation device 5, an amount of the second catalytic material affected thereby is relatively small, so the activation of the second catalytic material is hardly promoted. Accordingly, with the configuration according to this embodiment, as illustrated in (c) of FIG. 4, the rise or increase of the NOx reduction ratio in the catalytic device 4 will be delayed in comparison with the case where the same amount of the first catalytic material is uniformly distributed in the catalytic layer 43 of the catalytic device 4 (i.e., in the case where an equivalent amount of the second catalytic material is uniformly distributed). However, as illustrated in (a) of FIG. 4, at the time of the cold start of the internal combustion engine 1, an amount of NOx discharged from the internal combustion engine 1 immediately after the starting thereof is small. Then, the amount of NOx discharged from the internal combustion engine 1 increases with the rise of the combustion temperature after the starting of the internal combustion engine 1. Accordingly, even with the configuration according to this embodiment, the NOx reduction ratio of the catalytic device 4 can be raised in a period of time in which the amount of NOx discharged from the internal combustion engine 1 increases. Thus, it hardly occurs that an outflow amount of NOx flowing to the downstream side of the catalytic device 4 increases contrary to an improvement in the HC oxidation performance of the catalytic device 4. In addition, after the starting of the internal combustion engine 1, combustion control for suppressing the rise of the combustion temperature of the internal combustion engine 1 may be carried out until the NOx reduction ratio of the catalytic device 4 is raised to some extent by the activation of the second catalytic material included in the second catalytic layer 43b.

Further, in this embodiment, as mentioned above, the first catalytic layer 43a is formed in the catalytic layer 43 in a location which is the upstream portion thereof and the exhaust gas contacting portion. Here, in cases where the temperature of the exhaust gas is higher than the temperature of the catalytic layer 43, the upstream portion of the catalytic layer 43 is easily heated by the exhaust gas in comparison with the downstream portion thereof, and the exhaust gas contacting portion of the catalytic layer 43 is easily heated by the exhaust gas in comparison with the exhaust gas non-contacting portion thereof. Accordingly, in the catalytic layer 43, by forming the first catalytic layer 43a having a relatively high content ratio of the first catalytic material in the above-mentioned location thereof, it is possible to promote the temperature rise of the first catalytic material included in the first catalytic layer 43a. For that reason, further early activation of the first catalytic material can be attained.

Moreover, when the temperature of the upstream portion of the catalytic layer 43 rises, the heat generated in the upstream portion will easily conduct to the downstream portion thereof by the flow of the exhaust gas. For that reason, by promoting the temperature rise of the upstream portion of the catalytic layer 43, the temperature rise of the catalytic layer 43 as a whole can also be promoted. Accordingly, by forming the first catalytic layer 43a including the microwave absorber in the upstream portion, it is possible to attain early activation of not only the first catalytic material distributed over the first catalytic layer 43a but also the first catalytic material distributed over the second catalytic layer 43b formed in the downstream portion of the catalytic layer 43.

### (Modifications)

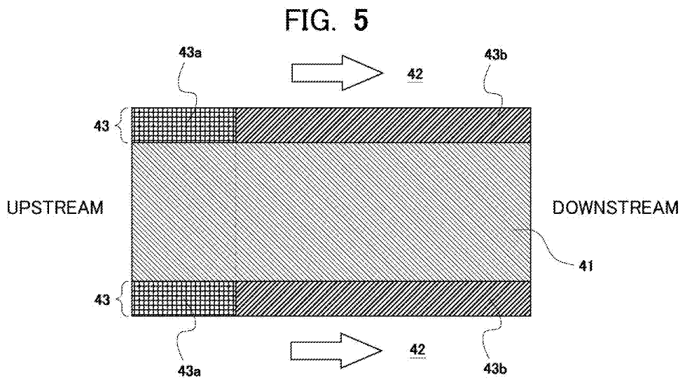

The method of distribution of the first catalytic layer 43a and the second catalytic layer 43b in the catalytic layer 43 of the catalytic device 4 is not limited to a distribution mode as illustrated in FIG. 3. FIG. 5 through FIG. 7 are views respectively illustrating modifications of the distribution of the first catalytic layer 43a and the second catalytic layer 43b in the catalytic layer 43 of the catalytic device 4. Here, note that in FIG. 5 through FIG. 7, white arrows (defined by outlines) indicate the direction of flow of exhaust gas flowing in cells 42, as in FIG. 3.

In a first modification as illustrated in FIG. 5, the first catalytic layer 43a is formed in the upstream portion of the catalytic layer 43. Also, in this first modification, unlike FIG. 3, the upstream portion of the catalytic layer 43 is not divided into the first catalytic layer 43a and the second catalytic layer 43b, but the entire upstream portion in the catalytic layer 43 constitutes the first catalytic layer 43a (i.e., both of the exhaust gas contacting portion and the exhaust gas non-contacting portion in the upstream portion of the catalytic layer 43 together constitute the first catalytic layer 43a). In such a configuration, too, when the temperature of the exhaust gas is higher than the temperature of the catalytic layer 43, the first catalytic layer 43a is easily heated by the exhaust gas, so the temperature rise of the first catalytic material included in the first catalytic layer 43a can be further promoted. Accordingly, further early activation of the first catalytic material distributed over the first catalytic layer 43a can be attained. In addition, in such a configuration, too, when the temperature of the first catalytic layer 43a rises, the heat generated in the first catalytic layer 43a will easily conduct to the second catalytic layer 43b by the flow of the exhaust gas. For that reason, it is possible to attain early activation of not only the first catalytic material distributed over the first catalytic layer 43a including the microwave absorber but also the first catalytic material distributed over the second catalytic layer 43b. Here, note that, as a further modification of the first modification illustrated in FIG. 5, there can also be adopted a configuration in which an upstream side catalytic device with the first catalytic layer 43a formed therein, and a downstream side catalytic device with the second catalytic layer 43b formed therein are separately formed from each other.

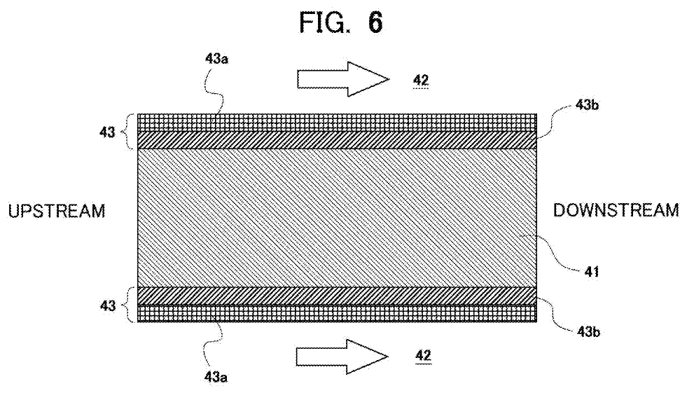

In addition, in a second modification as illustrated in FIG. 6, the first catalytic layer 43a is formed in the exhaust gas contacting portion of the catalytic layer 43. In this second modification, unlike FIG. 3, not only the upstream portion of the catalytic layer 43 but also the downstream portion thereof is divided into the first catalytic layer 43a and the second catalytic layer 43b, and the entire exhaust gas contacting portion in the catalytic layer 43 constitutes the first catalytic layer 43a. In such a configuration, too, when the temperature of the exhaust gas is higher than the temperature of the catalytic layer 43, the first catalytic layer 43a is easily heated by the exhaust gas, so the temperature rise of the first catalytic material included in the first catalytic layer 43a can be further promoted.

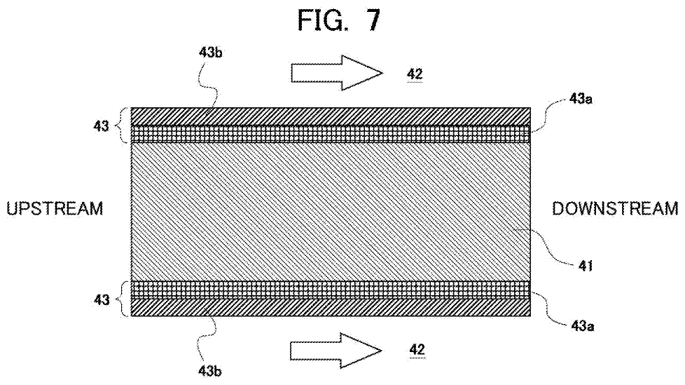

Moreover, in a third modification as illustrated in FIG. 7, in the catalytic layer 43, the second catalytic layer 43b is formed in the exhaust gas contacting portion thereof, and the first catalytic layer 43a is formed in the exhaust gas non-contacting portion thereof. Here, in cases where the temperature of the exhaust gas is lower than the temperature of the catalytic layer 43, heat is carried away from the catalytic layer 43 by the exhaust gas. However, even in such a time, in the catalytic layer 43, heat can not be easily carried away from the exhaust gas non-contacting portion by the exhaust gas in comparison with the exhaust gas contacting portion. Accordingly, by forming the first catalytic layer 43a in the exhaust gas non-contacting portion, it is possible to suppress the temperature of the first catalytic material once activated in the first catalytic layer 43a from becoming low due to carrying away of heat by the exhaust gas. For that reason, the activated state of the first catalytic material included in the first catalytic layer 43a becomes easy to be maintained.

Although in the above-mentioned embodiment and respective modifications, reference has been made to the case where the catalytic layer 43 is composed of the first catalytic layer 43a and the second catalytic layer 43b, the configuration of the catalytic layer 43 is not limited to this. For example, there can also be adopted a configuration in which a catalytic layer corresponding to the second catalytic layer 43b in the above-mentioned embodiment and its modifications is further divided into two layers in which the ratios of catalytic materials included therein are mutually different from each other.

What is claimed is:

1. A catalytic device which is arranged in an exhaust passage of an internal combustion engine, and which is irradiated with a microwave in the exhaust passage,
the catalytic device having a catalytic layer configured to include at least two kinds of catalytic materials that are different from each other in HC purification performance, and a microwave absorber to generate heat by absorbing the microwave, wherein
the microwave absorber is distributed over a predetermined part in the catalytic layer; and
in the predetermined part in the catalytic layer, a content ratio of a first catalytic material, which is one of the two kinds of catalytic materials of which HC purification performance is higher than that of the other, is higher than a content ratio of the first catalytic material in the other portion than the predetermined part in the catalytic layer.

2. The catalytic device as set forth in claim 1, wherein
the predetermined part in the catalytic layer is a portion thereof located at an upstream side along a flow of exhaust gas in the case where the catalytic device is arranged in the exhaust passage.

3. The catalytic device as set forth in claim 1, wherein
the catalytic device has a plurality of cells which are divided by a partition wall, and which allow exhaust gas to flow through their interiors in the case where the catalytic device is arranged in the exhaust passage;
the catalytic layer is formed on the partition wall; and
the predetermined part in the catalytic layer is a portion thereof located in a place which is directly exposed to the exhaust gas flowing through the interiors of the cells.

4. The catalytic device as set forth in claim 1, wherein
the catalytic device has a plurality of cells which are divided by a partition wall, and which allow exhaust gas to flow through their interiors in the case where the catalytic device is arranged in the exhaust passage;
the catalytic layer is formed on the partition wall; and
the predetermined part in the catalytic layer is a portion thereof located in a place which is not directly exposed to the exhaust gas flowing through the interiors of the cells.

5. An exhaust gas purification system for an internal combustion engine comprising:
a catalytic device, as set forth in claim 1, arranged in an exhaust passage of the internal combustion engine; and
an irradiation device configured to irradiate a microwave to the catalytic device in the exhaust passage.
